(19) United States
(12) Patent Application Publication
(10) Pub. No.: US 2008/0178475 A1
(43) Pub. Date: Jul. 31, 2008

(54) Twisted axe

(76) Inventor: Adam Antal Branovits, Staten Island, NY (US)

Correspondence Address: ADAM ANTAL BRANOVITS, 2. FL., 836 HUGUENOT AVE., STATEN ISLAND, NY, 10312-3921, US

(21) Appl. No.: 11/699,821

(22) Filed: Jan. 29, 2007

(51) Int. Cl. B26B 23/00

(52) U.S. Cl. 30/308.1

(57) ABSTRACT

My invention is a new axe because the axe's edge goes into the block of wood, and going in deeper, at this time the twisted head splits the block of wood. When the axe's head splits the block of wood, the axe's head goes in deep into the block of wood, and there the block of wood's pieces are touching the axe's head. Because of this the block of wood not only splits in a traditional way but splits in a twisted way, and this process will take a short time.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention belongs to the handy tools, which splits the block of wood. It's new in a way because the head of the axe is twisted in a different angle. It not only splits the block of wood, it splits the block of wood faster, and easier. Therefore it uses up less force and splits the block of wood faster.

2. Prior Art

In the splitting the block of wood the axe goes into the block of wood and starts splitting it. The block of wood's inside structure specifies the shape of the axe. My invention will not have the same shape as the traditional axes. It is new in that the head of the axe is twisted in a new way. Also, it is easier to use, and splits the block of wood faster. I am going to write down some inventions that tried to be effective in splitting the block of wood.

One is U.S. Pat. No. 4,926,558 Brace (1990) and the other one is U.S. Pat. No. 4,044,808 Kolonia (1977). My invention is more effective then the previous inventions because it splits the block of wood faster and easier. Also, my invention is more effective, simple, and splits the block of wood faster.

### BACKGROUND OF INVENTION—OBJECTS AND ADVANTAGES

(a) to provide a faster and easier way to split the block of wood

(b) to provide an easy way to use the axe in a way that will split the block of wood faster

(c) to provide the invention in a way it's easier to manufacture in a traditional way

(d) to provide the same weight (not heavier) product like the traditional ones we use today but a more effective invention

(e) to provide the use of the invention, and it can be repaired in a traditional way

(f) to provide my invention is completely new, and it is used in today's technical level

(g) to provide a showy, shapely product, and easy to sell invention

### SUMMARY

My invention is an axe which it's head is twisted 90 degrees. When splitting the block of wood the axe's edge goes into the block of wood causing it to split the wood. The head of the goes into the block of wood deeper. At this time the block of wood's pieces are touching the axe's head. Because the shape of the axe's head, the block of wood's pieces are twisted, and split into smaller parts.

### DRAWINGS—FIGURES

FIG. 1 shows front side view

FIG. 2 shows rear side view

FIG. 3 shows right side view

FIG. 4 shows left side view

FIG. 5 shows top side view

FIG. 6 shows bottom side view

FIG. 7 shows perspective view

FIG. 8 shows perspective and shaded view

### DRAWINGS—REFERENCE NUMERALS

| | |
|---|---|
| 1 | helve |
| 2 | helve |
| 3 | the twisted part |
| 4 | axe's edge |
| 5 | the twisted part |
| 6 | the helve's hole |
| 7 | axe's edge |
| 8 | the twisted part |
| 9 | the edge which splits the block of wood |
| 10 | the twisted part |
| 11 | helve's details |
| 12 | axe's edge |
| 13 | the twisted part which splits the block |
| | of wood |
| 14 | the helve's hole |

### DETAILED DESCRIPTION—FIGS

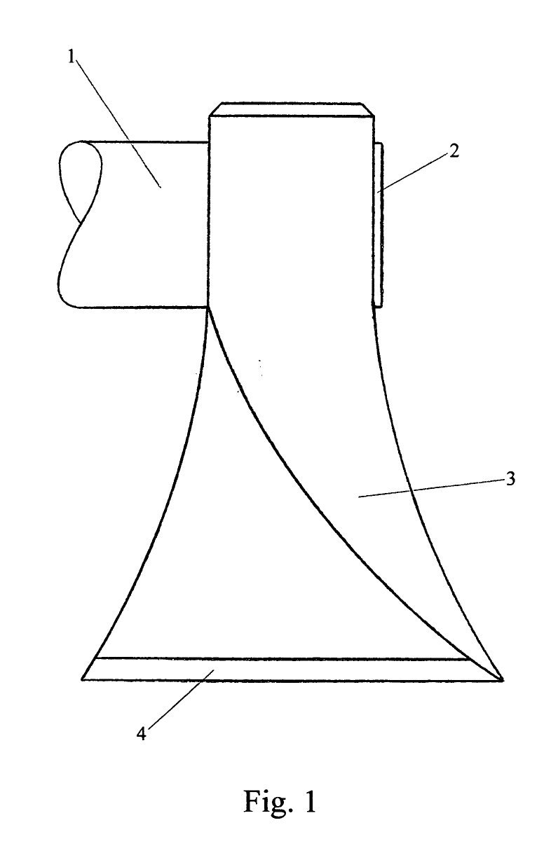

My invention is an axe which it's head is twisted, seen on FIG. 1 in a front side view. Here are seen the details of the helve, number 1 and 2. The twisted part of the axe's head is number 3. The twisted part is number 3. It splits the block of wood in a twisted way. Number 4 shows the edge of the axe. When splitting the block of wood, first the axe's edge goes into the block of wood causing it to split the wood.

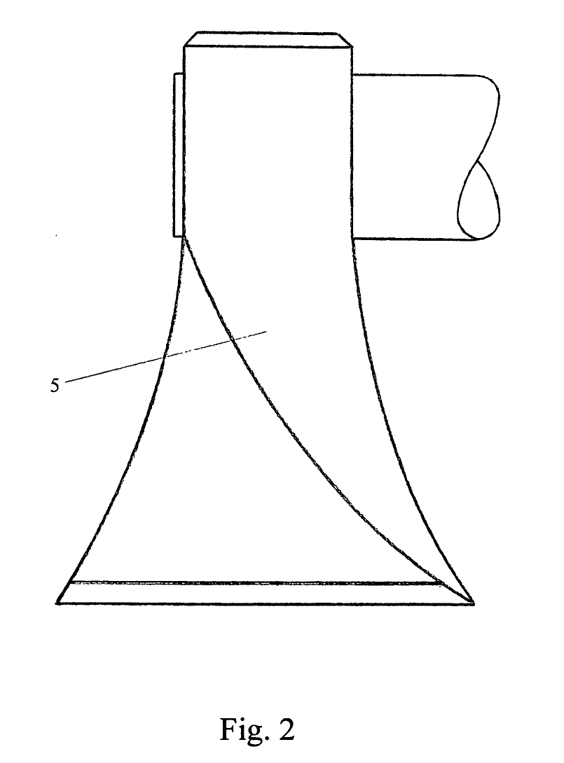

In the rear side view FIG. 2, the axe's head is symmetric. Here number 5 shows the twisted part of the axe's head. On both sides of the twisted head, numbers 3 and 5 shows the twisted part.

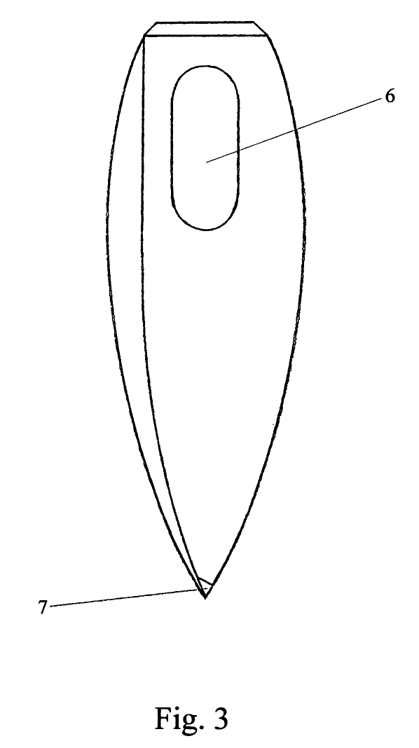

The twisted axe's head is shown in FIG. 3. Here the helve's hole is seen at number 6, and the axe's edge at number 7.

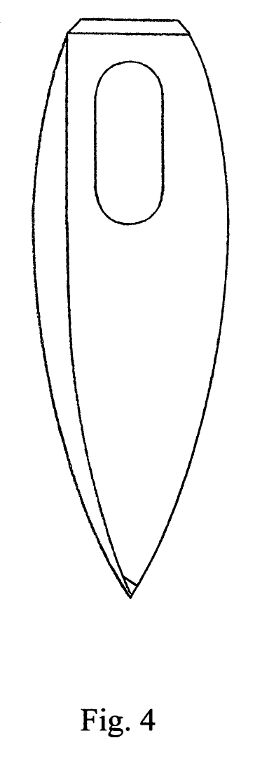

On FIG. 4, I didn't write any numbers because FIG. 3 and FIG. 4 is the same thing.

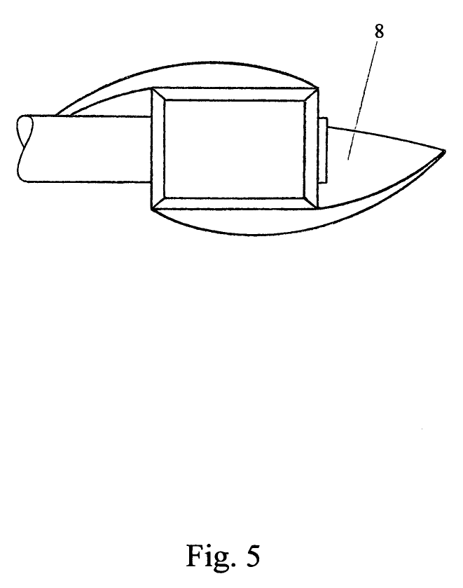

On FIG. 5, number 8 shows the twisted part from a top side view.

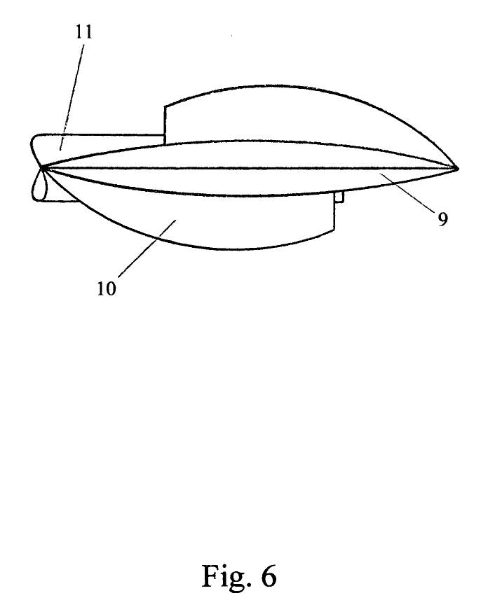

FIG. 6 shows the bottom side view, where the axe's edge number 9, the twisted part number 10, and the helve's details number 11 are shown.

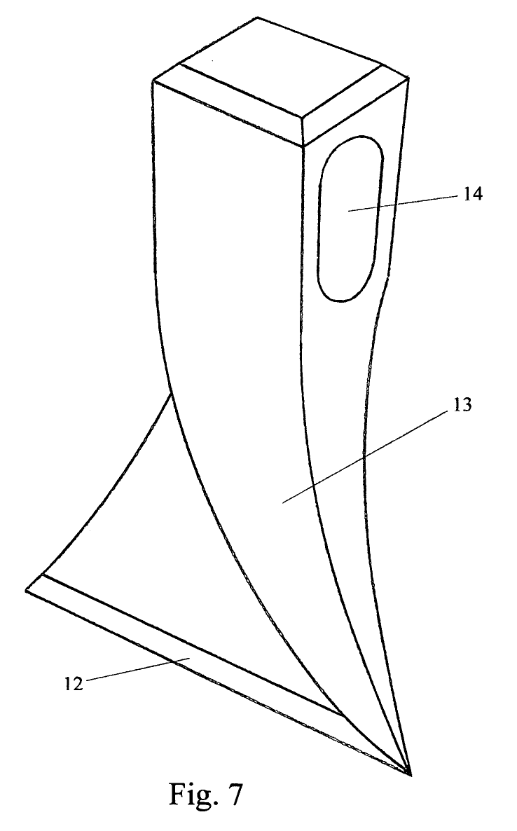

FIG. 7 shows the perspective view, where the helve's hole is seen number 14. Also the twisted part number 13, and the axe's edge which goes into the block of wood first number 12 are seen at FIG. 7.

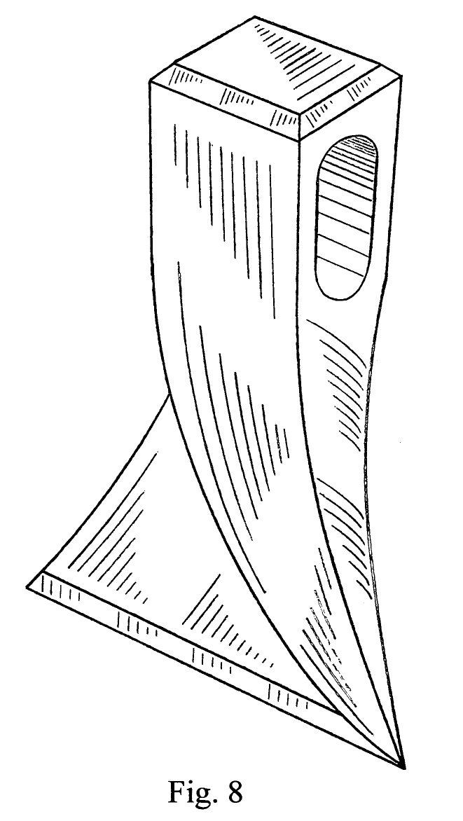

FIG. 8 is shadowed, which shows the twisted parts on the axe's head. Number 13 shows the twisted part, which splits the block of wood in a twisted way. The woods are threadlike. Splitting of the block of wood, we will split the block of wood with the axe's edge in a parallel way. When splitting the block of wood the axe's edge goes between the threads and it will separate them. When splitting the block of wood in a twisted way it will be easier than the traditional way. Number 13 causes the block of wood to split in a twisted way. When cutting the wood the axe's head cuts the thread's of the wood in a perpendicular way. My invention can also cut it in a perpendicular way because it has the traditional axe's edge. Also my invention's head is made out of steel, and the helve can be made out of wood, plastic, or steel.

1. An axe splits the block of wood. During the process of splitting the block of wood, the axe's head closely touches the block of wood, which is about to split.

2. An axe's twisted head causes the block of wood to be split in a twisted way.

3. An axe is a traditional handy tool, which its edge goes into the block of wood. The axe's head goes into the block of wood deeper, and there it splits the block of wood in a twisted way.

4. An axe is individual in a way that it's head is twisted and it can be used as a handy tool, but can also use it's twisted head on axe maul apparatus. If we put the twisted head on the axe maul apparatus, the axe maul apparatus will work faster, efficiently, and will use up less energy.
